(19) United States
(12) Patent Application Publication
(10) Pub. No.: US 2005/0022731 A1
(43) Pub. Date: Feb. 3, 2005

(54) Immersion optics fluid dispenser

(76) Inventors: Bernard Petrillo, Rye, NY (US); Bruno Israel, Kinderhook, NY (US)

Correspondence Address: RHODES INSTRUMENT CORPORATION, 11 VIRGINIA ROAD, N. WHITE PLAINS, NY, 10603, US

(21) Appl. No.: 10/604,569

(22) Filed: Jul. 30, 2003

(51) Int. Cl. B05C 5/00

(52) U.S. Cl. 118/300; 359/391

(57) ABSTRACT

To increase the optical resolution, microscope users routinely employ high aperture lenses. The highest resolution is attained through the use of immersion lenses with associated immersion fluids. A non-interfering delivery system is herein described to accurately dispense a controlled amount of this fluid precisely at the proper interface location.

### BACKGROUND OF INVENTION

1. Field of the Invention

This invention relates to the need to simplify and accurately dispense the application of immersion fluid for immersion optical systems.

2. Description of the Prior Art

No mechanism exists to accomplish the task of dispensing the immersion fluid. Presently, the fluid is dispensed manually utilizing an eye dropper or its equivalent. For upright microscopes, It is not uncommon for excessive fluid to be dispensed on the specimen using this technique. When using an inverted microscope, the user must apply the drop of fluid on the objective lens which can be partially obscured as it is nested inside, or below, the microscope stage.

### SUMMARY OF INVENTION

It is the object of this invention to provide the microscope user with a device that will accurately dispense the precise amount of immersion fluid at the proper location.

It is another object of this invention to accomplish these tasks in either a manual mode with minimal mechanical demands on the user, or in an automated configuration.

The satisfaction of these objectives will result in a cleaner working environment, less waste of the immersion fluids, and the elimination of the awkward and inaccurate application procedures currently in use.

### BRIEF DESCRIPTION OF DRAWINGS

In the drawings:

FIG. 1 is a side view of the dispensing mechanism.

FIG. 2 is a top view of the dispenser in its stowed condition.

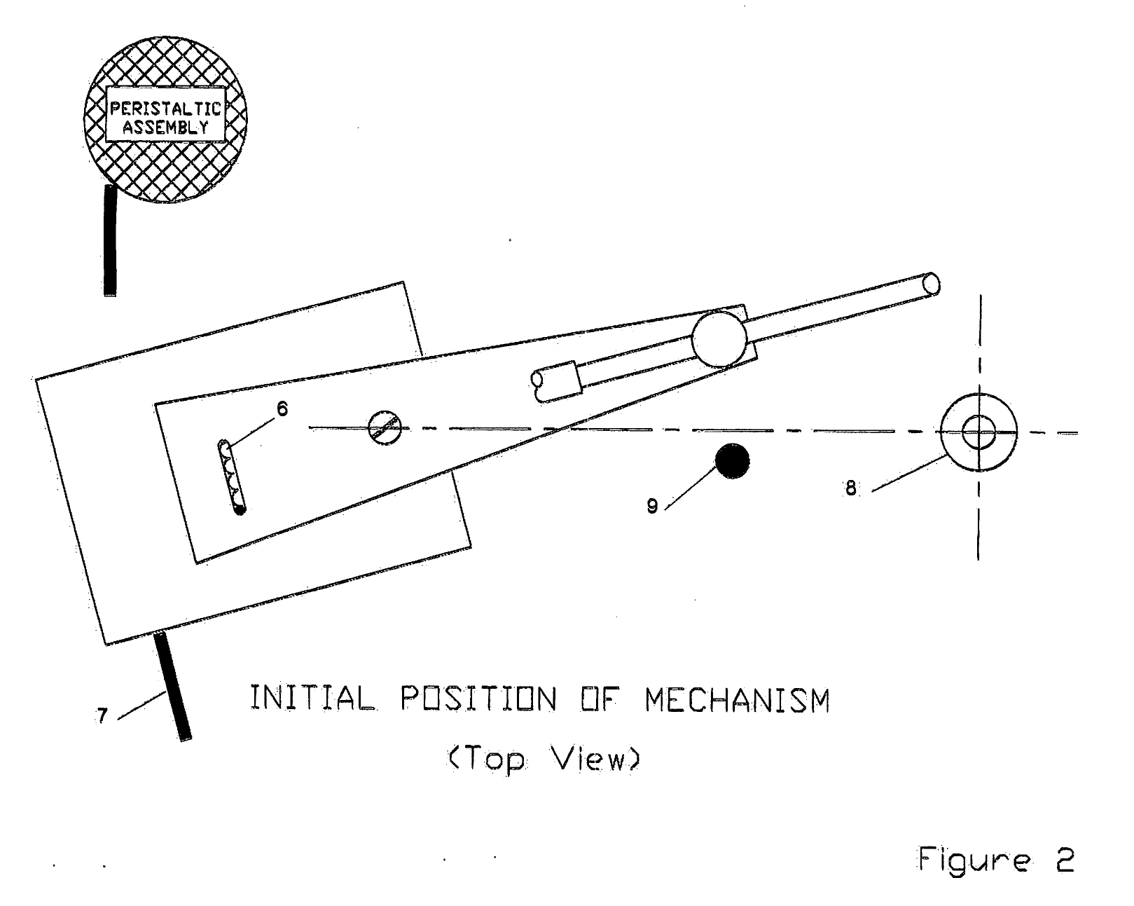

FIG. 3 is a top view of the dispenser in position to dispense the fluid.

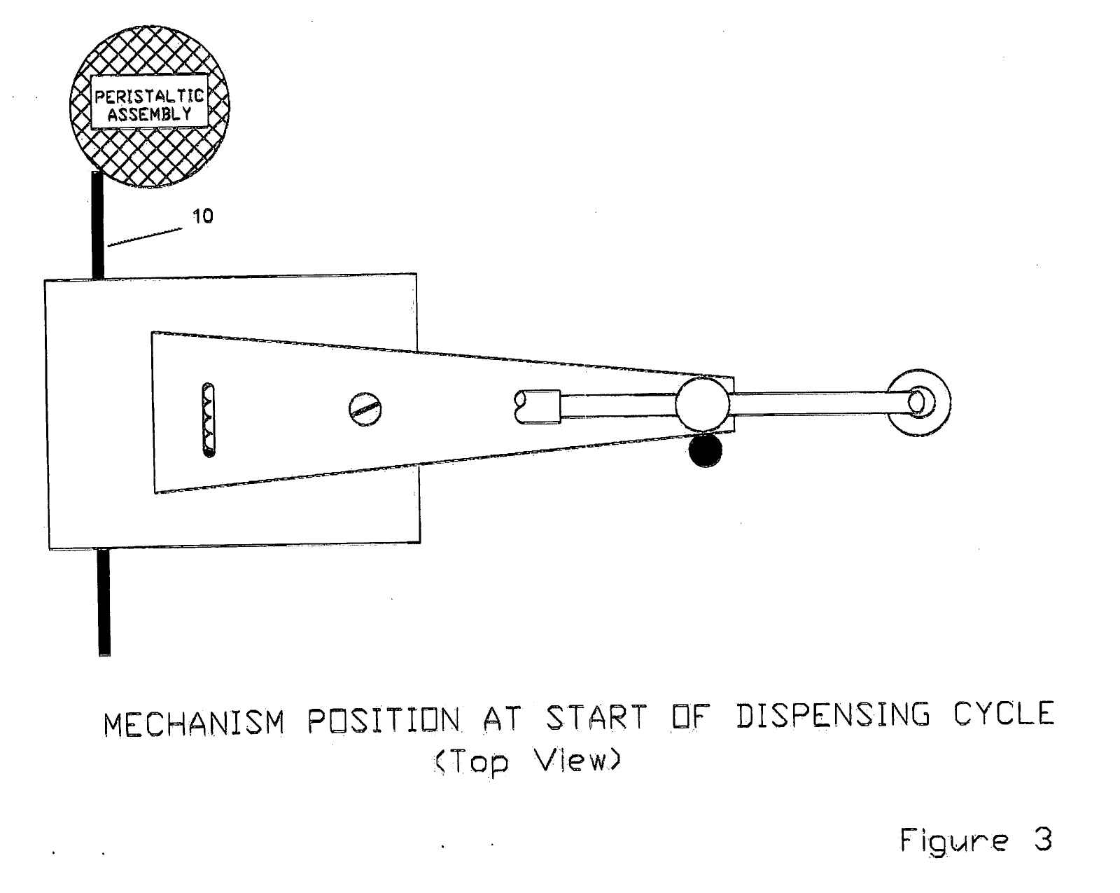

FIG. 4 is a top view of the dispenser at the end of the dispensing cycle.

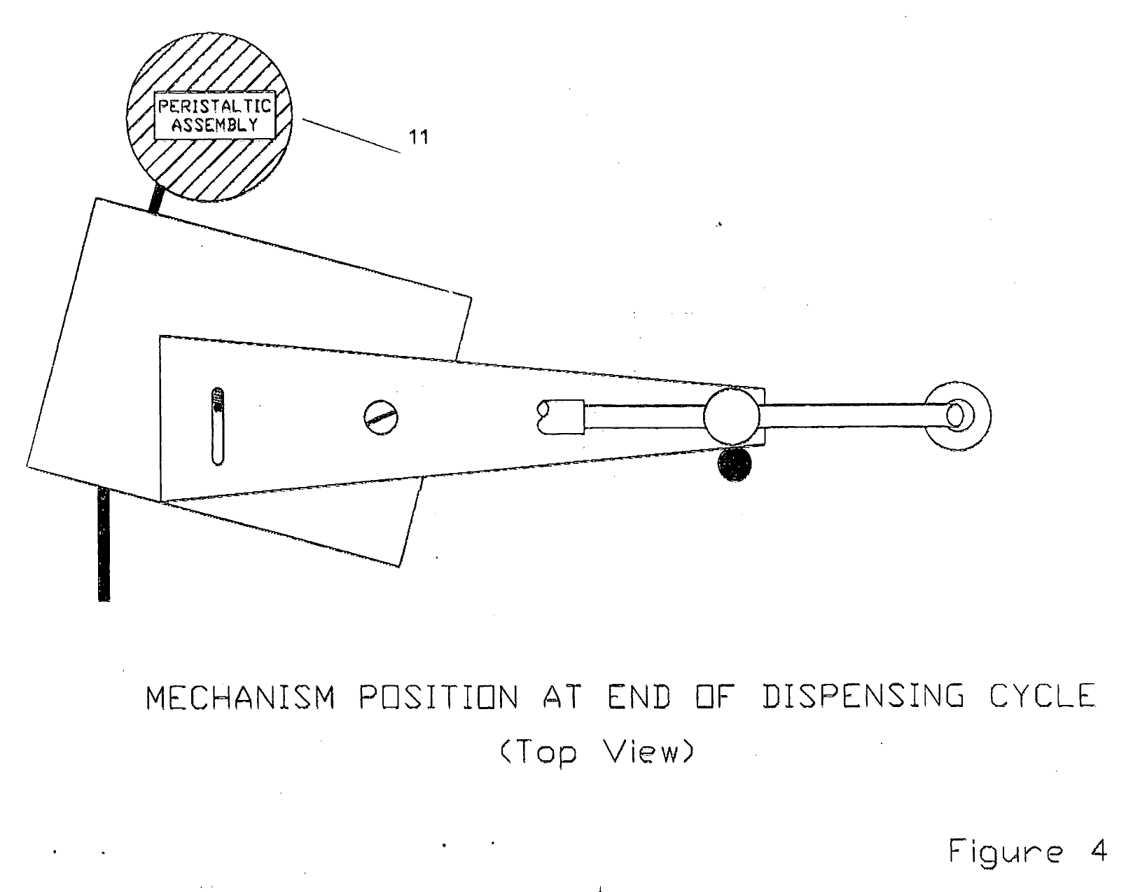

FIG. 5 is a functional drawing of the peristaltic dispensing assembly.

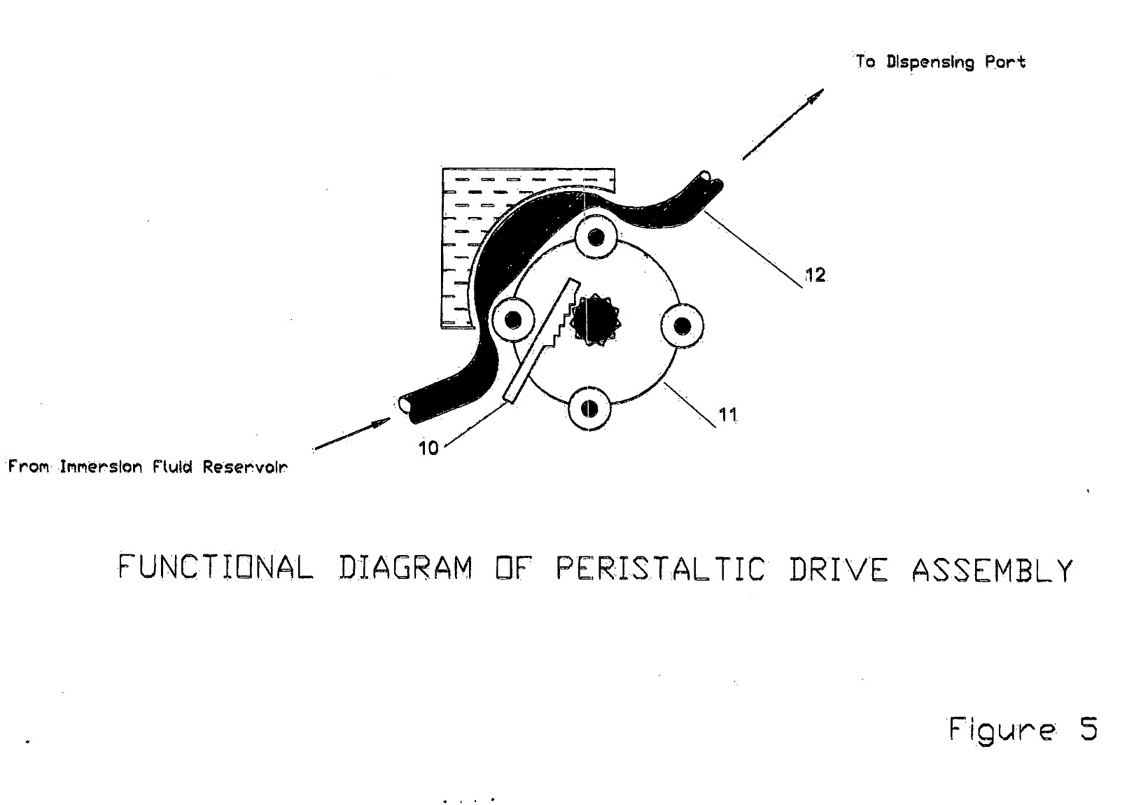

### DETAILED DESCRIPTION

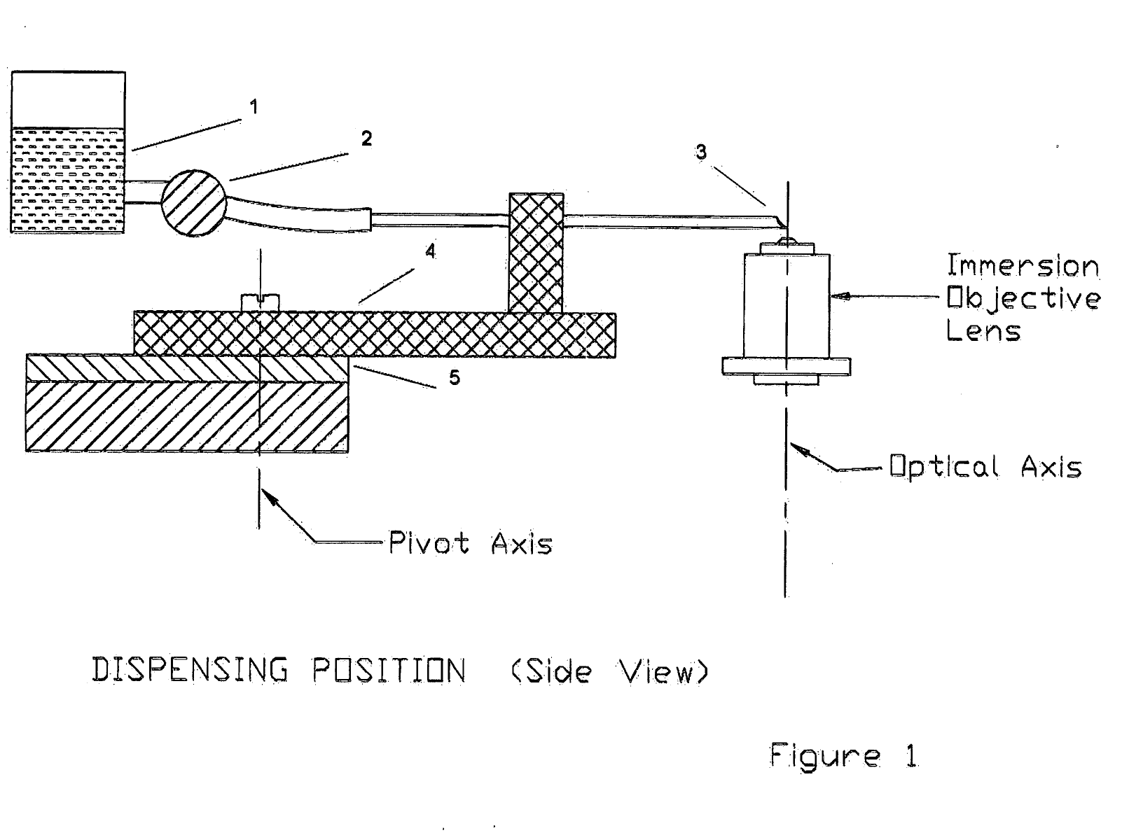

FIG. 1 is a functional diagram of the dispensing system for an inverted microscope. The desired immersion fluid is contained in the reservoir 1. Whenever the peristaltic driver is actuated, fluid is drawn into the peristaltic processing chamber 2 and pushed out through the dispensing port 3.

The mechanical actuator is a two-stage device with an upper section 4 and a lower section 5. Both sections share a common pivotal axis. The upper section contains a constrained spring 6 that initially forces the upper section to rotate in concert with the lower section.

As the flexible driving plunger 7 is initially displaced, it rotates the complete assembly about the pivot and positions the output port of the drop dispenser into position above the front objective lens 8. At this point, the upper section encounters the fixed stop 9 and ceases rotating. Further displacement of the plunger causes the lower section to overcome the spring's static force. The lower section continues to rotate and a linear actuator 10 drives the ratcheting roller bearing assembly 11. By peristaltic action, the immersion fluid is squeezed from the peristaltic chamber 12 out and through the dispenser outlet port.

1. An immersion fluid dispenser for microscopes that manually deposits the proper amount of fluid on the specimen (upright systems) or front lens (inverted systems) for immersion optics applications.

2. The dispenser of claim 1, further comprising:
a two-stage mechanical configuration that both positions the dispensing port from a remote location to the desired application point and then delivers the proper amount of immersion fluid.

3. The dispenser of claims land 2, further comprising:
the ability to be combined with a fluid extraction system for the removal of the deposited fluid at the completion of immersion optics task.

4. The dispenser of claim 1, 2, or 3, further comprising:
the ability to automatically sense the particular objective lens in use and correspondingly modify the drop dispensing parameters.
